(19) United States
(12) Patent Application Publication
(10) Pub. No.: US 2006/0172253 A1
(43) Pub. Date: Aug. 3, 2006

(54) Methods, apparatus, and products for making dental impressions, and products made therefrom

(76) Inventors: Willis J. Pumphrey JR., Missouri City, TX (US); John Kendall Hackbarth, Texas City, TX (US)

Correspondence Address: J. M. (Mark) Gilbreth;GILBRETH & ASSOCIATES, P.C., P.O BOX 2428, BELLAIRE, TX, 77402-2428, US

(21) Appl. No.: 11/048,572

(22) Filed: Jan. 31, 2005

(51) Int. Cl. A61C 9/00

(52) U.S. Cl. 433/37; 433/214

(57) ABSTRACT

A method and impression tools for making a dental impression, with the method including first applying a spacer material to a preliminary impression material to form a preliminary impression tool, and then contacting the tool against the dental surface to form a preliminary dental impression in the preliminary impression material. The method further includes separating the tool from the dental surface, and then removing the spacer material from the tool to reveal the preliminary dental impression. The method then includes applying a final impression material to the preliminary impression to form a final impression tool, which is then contacted against the dental surface to form a final impression of the tooth surface in the final impression material.

### BACKGROUND OF THE INVENTION

The present invention relates to methods, apparatus and products for making impressions of an object, to products made therefrom, and for methods, apparatus, and products for making such products. In another aspect, the present invention relates to methods, apparatus and products for making dental impressions, to dental devices made therefrom, such as inlays, onlays, crowns and bridges, prosthetic devices and orthodontic devices, and to methods, apparatus and products for making such dental devices.

Dental impressions are useful for providing detail of a patient's dental anatomy for the creation of a whole host of dental devices such as inlays, onlays, crowns, bridges, prosthetic devices such as full or partial dentures, and orthodontic devices such as retainers or aligners (for example, the Invisalign™ aligner).

Because each patient's mouth is unique in structural features, the making of an effective comfortable dental device requires that it be closely fitted to the precise requirements of the individual. To ensure a close fit, an impression composition, comprising a natural or synthetic polymer that will set to a retained form, is applied to the areas to be replicated. The impression composition is necessarily impressionable and thus fluid. To carry the impression composition into the mouth, a dental impression tray is used. These trays comprise a base and a curvilinear trough generally sized and shaped to fit into the mouth and register with the patient's teeth.

The known impression process involves placing impression material into the impression tray and then inserting the tray into the patient's mouth to create the impression. The doctor maneuvers or manipulates the tray within the patient's mouth relative to the teeth until the appropriate position is achieved and thereafter holds or has the patient hold the tray in this position. The impression material cures while it is inside the mouth. Once completed to an adequate cure state, the doctor removes the cured impression from the patient's mouth.

The impression material converts to a solid having in the negative the profile of the teeth and gums impressed into it. This impression is then used to form a model, which is a positive of the teeth and gums. Then the dental device (i.e., inlay, onlay, crown, bridge, prosthetic device or orthodontic device) is fabricated using the model. Obviously, in all these steps errors in dimensions either from a faulty impression, a tearing of the set impression composition, or a shrinkage or other distortion of the impression composition will adversely affect subsequent steps and result in a poor-fitting product.

The are numerous patents relating to dental impressions, including patents disclosing various and numerous types of impression trays, impression materials, impression methods, and products, with the following being merely an ever so small sampling of a few.

U.S. Pat. No. 4,995,540, issued Feb. 26, 1991, to Colin et al. discloses a unit dosage dispenser for dental impression materials wherein the high and low viscosity materials are dispensed from a syringe-type device. The materials are provided in such a way that the low viscosity material is dispensed from the device first, followed by the high viscosity material. While this device addresses some concerns associated with the hand mixing of dental impression materials, it suffers drawbacks related to the timing of dispensing and applying the high and low viscosity materials from the device. For example, because the materials are contained in a common dispenser, they must be dispensed relatively contemporaneously with one another. The temporal dependence of dispensing the two materials may create problems when the set time or work time of the materials are not closely matched. Moreover, all of the low viscosity material must be dispensed before the high viscosity material may be applied to a dental tray.

U.S. Pat. No. 6,045,359, issued Apr. 4, 2000, to Tucker, discloses a dental impression tray having a handle and a mouthpiece. The mouthpiece contains an upper portion and a lower portion defined as a means for laterally displacing excess impression material. The upper portion of the mouthpiece, which holds the impression material, is defined by outer and inner walls having arcuate shapes, a base attached to and extending the length of the bottom of the outer and inner walls, a plurality of elongated vent holes in the base, and a serpentine occlusal stop ridge extending from the top of the base. Therein the outer edge of the inner wall of the upper portion of the tray are a plurality of holes which force excess impression material to extrude to the means for laterally displacing excess impression material. Excess impression material extruded from the holes flow laterally across the horizontal surface and interlock with the excess material extruded from the elongated vent holes thereby securely attaching the impression material to the mouthpiece. Moreover, the elimination of the palate on the impression tray, which creates the impression of the upper dentition by the present invention, decreases the likelihood of inducing a patient's gag reflex. Extrusion of excess material to the horizontal surface also causes only the requisite amount of impression material to remain in the upper portion of the tray. The combination of the improvements of the present invention produces an overall more comfortable and accurate impression tray.

U.S. Pat. No. 6,198,840, issued Mar. 6, 2001, to Zentz et al., discloses a heat formable tray having a bite block and a method of forming the tray to a patient and forming a final impression in a single visit to the dental office by the patient. A custom fitting variable dimension bite registration dental impression tray, is provided which includes a bite registration member, and a dental impression tray. The dental impression tray comprises a heat adjustable material having a softening point above 38 degree C. and below 120 degree C. The variable dimension bite registration dental impression tray is used in a method for making an impression of dental tissue, comprising the steps of: a) providing a variable dimension bite registration dental impression tray, b) heating the dental impression tray to softened state, c) adjusting the dimensions of the dental impression tray, d) cooling the heat adjustable material so that it solidifies; and e) enveloping the tissue with the dental impression material, whereby a final dental tissue impression is obtained.

U.S. Pat. No. 6,835,065, issued Dec. 28, 2004, to Wise, discloses a dental impression tray for obtaining an impression of a patient's dentition has a pair of spaced apart limbs spanned by a support for impression material. Each limb has a buccal wall that extends beyond the level of the support and a lingual row of spaced apart projections which also extend beyond the level of the support. Between the buccal wall and the adjacent row of projections is a web pierced by a plurality of openings. The impression material support is a mesh having openings therethrough. The buccal wall, the upstanding projections, the openings in the web, and the openings in the mesh provide an interlock between the dental impression material and the tray, which restrains relative movement between the latter and the impression material during the forming of an impression of the patient's dentition.

U.S. Pat. No. 6,843,652, issued Jan. 18, 2005, to Xie et al., discloses a method for taking impressions in which as a low viscosity material is generally applied directly to the teeth, using for example, a syringe, and a separate higher viscosity material is placed into a dental tray for subsequent application to the teeth by inserting the tray into the patient's mouth and having the patient bite onto the tray.

However, in spite of the advances of the prior art, there still exists a need in the art for improved methods, apparatus and products for making dental impressions, for improved methods, apparatus and products for making dental devices, for dental devices made thereby and therefrom.

This and other needs in the art will become apparent to those of skill in the art upon review of this application, including its specification, drawings and claims.

### SUMMARY OF THE INVENTION

It is an object of the present invention to provide for improved methods, apparatus and products for making dental impressions, for improved methods, apparatus and products for making dental devices, and for dental devices made thereby and therefrom.

This and other objects of the present invention will become apparent to those of skill in the art upon review of this application, including its specification, drawings and claims.

According to one embodiment of the present invention, there is provided a method of making a final impression of an object surface, the method includes applying a spacer material to an impression material to form a preliminary impression tool. The method further includes contacting the object with the preliminary impression tool in such a manner that the surface abuts the spacer material forming a preliminary impression of the object surface in the impression material. The method even further includes separating the preliminary impression tool from the object. The method still further includes removing the spacer material from the preliminary impression tool to reveal the preliminary impression of the object surface. The method yet includes applying a final impression material to the impression of the object to form a final impression tool. The even still includes contacting the final impression tool against the object in such a manner as to orient the object in the preliminary impression of the object forming a final impression of the object surface in the final impression material. As a further embodiment, this method may optionally include making a model of the object from the final impression, and making other products from the model.

According to another invention of the present invention, there is provided a method of making a final impression of a tooth surface, the method includes applying a spacer material to an impression material to form a preliminary impression tool. The method further includes contacting the tooth surface with the preliminary impression tool in such a manner that the surface abuts the spacer material forming a preliminary impression of the tooth surface in the impression material. The method even further includes separating the preliminary impression tool from the tooth surface. The method still further includes removing the spacer material from the preliminary impression tool to reveal the preliminary impression of the tooth surface. The method yet further includes applying a final impression material to the impression of the tooth surface to form a final impression tool. The method even still further includes contacting the final impression tool against the tooth surface in such a manner as to orient the tooth surface in the preliminary impression of the tooth surface forming a final impression of the tooth surface in the final impression material. As a further embodiment, this method may optionally include making a model of the tooth surface from the final impression, and making dental devices from the model, such as inlays, outlays, crowns, bridges, prosthetic devices, and orthodontic devices.

According to even another embodiment of the present invention, there is provided an impression spacing set comprising a backing sheet, a first spacer shaped to fit into a lower dental tray, and a second spacer shaped to fit into an upper dental tray. As a further embodiment, there are provided dental devices made using this impression set (i.e., impression set is used to take impression, which is in turn used to make a model from which the device is made).

According to still another embodiment of the present invention, there is provided a method of making impression spacing set, comprising removably connecting to a backing sheet, a first spacer shaped to fit into a lower dental tray, and a second spacer shaped to fit into an upper dental tray.

According to yet another embodiment of the present invention, there is provided an impression tool comprising a dental impression material, and a spacer material supported by the impression material. As a further embodiment, there are provided dental devices made using this impression tool (i.e., impression set is used to take impression, which is in turn used to make a model from which the device is made).

According to even still another embodiment of the present invention, there is provided a method of making an impression tool, the method comprising a applying spacer material to an impression material.

According to even yet another embodiment of the present invention, there is provided an impression tool comprising for taking an impression of a surface, comprising a first impression material defining a preliminary impression of the surface, and a second impression material residing in the impression of the surface. As a further embodiment, there are provided dental devices made using this impression tool (i.e., the impression set is used to take impression, which is in turn used to make a model from which the device is made).

According to still even another embodiment of the present invention, there is provided a method of making an impression tool for taking an impression of a surface, the method comprising, providing a first impression material defining a preliminary impression of the surface, applying a second impression material into the preliminary impression.

According to still yet another embodiment of the present invention, there are provided methods of making dental devices, which incorporate part or all of any of the above methods into a process of making dental devices.

According to even still yet another embodiment of the present invention, there are provided dental devices made by methods, which incorporate part or all of any of the above methods into a process of making dental devices.

According to still even yet another embodiment of the present invention, there are provided dental devices made from impressions or models obtained using part or all of the above methods.

### BRIEF DESCRIPTION OF THE DRAWINGS

FIG. 1 is an illustration of impression spacer set 100 having backing sheet 101, lower impression spacer 102, and upper impression spacer 103.

FIG. 2 is an illustration of impression spacer set 100 of FIG. 1, showing impression spacer 102 removed from backing sheet 101, and showing impression spacer 103 having portion 103A partially removed.

FIG. 3 is an illustration of a typical impression tray 110 with handle 113.

FIG. 4 is an illustration of preliminary impression maker 130 being assembled, showing impression tray 110 into which has been placed impression material 112, and showing impression spacer 102 that is to be placed on top of impression material 112.

FIG. 5 is an illustration showing assembled preliminary impression maker 130 comprising impression tray 110, impression material 112 residing in impression tray 110, with impression spacer 102 on top of impression material 112.

FIG. 6 is an illustration showing preliminary impression maker 130 being inserted into mouth 121 of patient 120 by dental professional 128.

FIG. 7 is an illustration showing preliminary impression maker 130 being unassembled, showing impression spacer 102 being removed, revealing preliminary dental impressions 112A.

FIG. 8 is an illustration showing final impression maker 130A being assembled by application of final impression material 133 over preliminary dental impressions 112A with applicator 132.

FIG. 9 is a side view of final impression maker 130A of FIG. 8 at 9-9, showing impression tray 110, dental impression layer 112 with preliminary impressions 112A, and final impression material 133.

FIG. 10 is an illustration of final impression maker 130A inserted into mouth 121 of patient 120.

FIG. 11 is an illustration of final impression maker 130A removed from patient's mouth having final impressions 133A.

FIG. 12 is an illustration of an alternative impression tray 110 for taking upper mouth impressions.

### DETAILED DESCRIPTION OF THE INVENTION

The present invention will be illustrated preferably by reference to dental applications, non-limiting examples of which include inlays, onlays, crowns and bridges, removable prosthetic devices and orthodontic devices, more preferably by reference to orthodontic devices, and even more preferably by reference to aligners.

However, it should be understood that the present invention is also believed to be useful outside of the dental art, and has applicability in any endeavor in which it is desired to obtain a mold of an object, non-limiting examples of which include facial/body part molds for reconstructive/cosmetic surgery, in forensic investigations for obtaining molds of tire, footprint and other imprints at a crime scene, in the creating of detailed models of objects, and in the making of sculptures.

The general method of the present invention of making an impression of an object surface includes applying a spacer material to an impression material to form a preliminary impression tool. This spacer material is selected for the application at hand, and may be in the form of a sheet or film, or may be applied as a liquid, gel, or semi-solid, which will dry into a sheet or film.

Optionally, this impression material may be supported on a substrate for ease of handling. This optional substrate may be designed specifically for the application at hand. For example, in the dental art, an impression material is generally supported upon a dental impression tray and then abutted against the teeth. The present invention is not to be limited any specific type of substrate. Further, any impression material suitable for the application at hand may be utilized. Again referring to the dental art, there are a number of well know impression materials, and any suitable one may be utilized.

The method further includes contacting this preliminary impression tool with the object in such a manner that the surface abuts the spacer material forming an impression of the object surface in the impression material. The method even further includes separating the preliminary impression tool and object after a suitable set time, which will vary according to the impression material selected. The method still further includes removing the spacer material from the preliminary impression tool to reveal the impression of the object surface in the preliminary impression material. The method yet further includes applying a final impression material to the impression of the object to form a final impression tool. The method even still further includes contacting the object and the fine impression tool in such a manner as to orient the object in the previously formed impression of the object forming an impression of the object surface in the final impression material. From this final impression may be formed a model of the object, and from the model various other objects may be produced.

The impression method of the present invention shall now be described in more detail with respect to a dental application and by reference to the Figures.

Dental impressions are generally taken utilizing an impression tray, which may be designed for partial, full lower, full upper, or even dual arch trays for simultaneously capturing both upper and lower impressions. While not specifically necessary, such an impression tray is strongly suggested as it makes handing the impression material more practical.

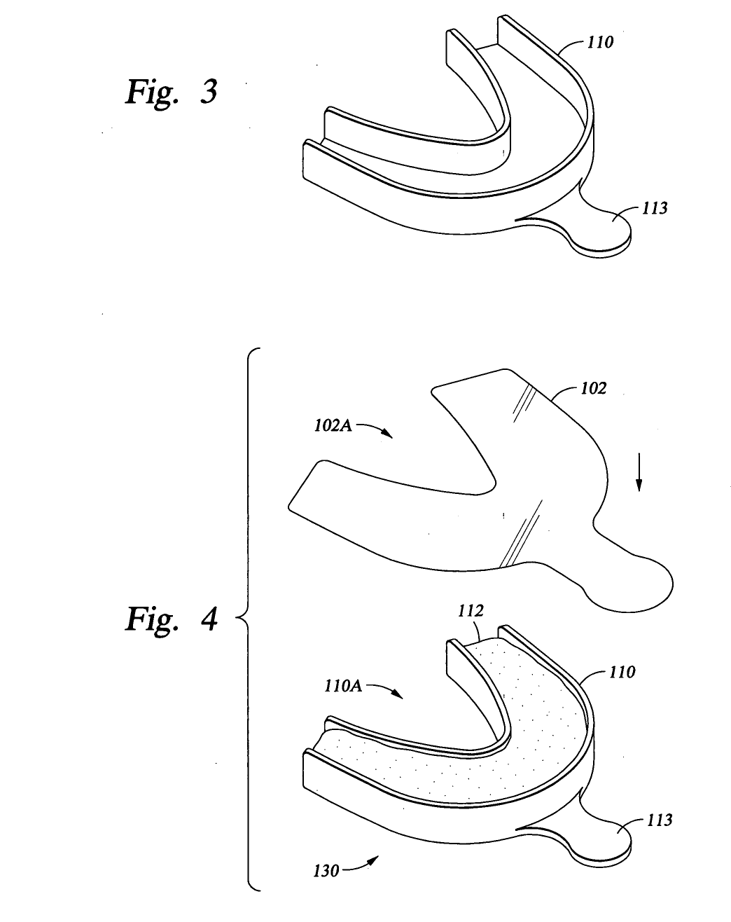

Referring now to FIG. 3, there is shown an illustration of a typical impression tray 110 with handle 113. Such an impression tray 110 is considered to be for taking lower impressions as it defines zone 110A for accommodating the tongue. It should be understood that the present invention is not limited to any particular suitable impression tray or other substrate, and that any suitable tray/substrate may be utilized in the present invention. Non-limiting examples of suitable impression trays (and impression methods) include those disclosed in U.S. Pat. Nos. 6,835,065, 6,768,671, 6,749,428, 6,629,841, 6,527,549, 6,468,078, 6,457,973, 6,450,808, 6,457,292, 6,428,315, 6,379,147, 6,364,661, 6,302,690, 6,247,925, 6,213,768, 6,196,840, 6,079,977, 6,045,359, 6,017,217, 5,890,895, 5,890,894, 5,772,432, 5,752,826, 5,733,118, 5,718,577, 5,702,250, 5,636,985, 5,582,517, 5,554,024 and 5,316,474.

If a tray is to be utilized, then the impression material is applied to the tray. Referring additionally to FIG. 4, there is shown an illustration of preliminary impression maker 130 being assembled, showing impression tray 110 into which has been placed preliminary impression material 112. General selection criteria for impression materials include taste, odor, toxicity, viscosity, cure speed, ease of demolding, strength after cure, and accuracy of the formed impression. Very typically, if utilized in the United States, the impression material will have to meet one or more American Dental Association (ADA) Specifications 16, 18, 19 and/or 20. Commonly known impression materials include agar, alginates, polysulfides, polyethers, polysilicone, polysiloxanes, polysulfides, and zinc oxide-eugenols.

The two most popular dental impression materials used by dental professionals are the vinyl polysiloxane (VPS) and the alginate-based impression materials. In fact dental professionals take millions of these types of impressions each year. Alginate is one of the most popular impression materials due to its accuracy, ease of removal from the teeth, inexpensive price, and ease of use. The VPS's are quite popular because they are extremely accurate, rigid, dimensionally stable, and give predictable results, although they are much more expensive. It should be understood that the present invention is not to be limited to any particular type of impression material, and any suitable impression material may be utilized.

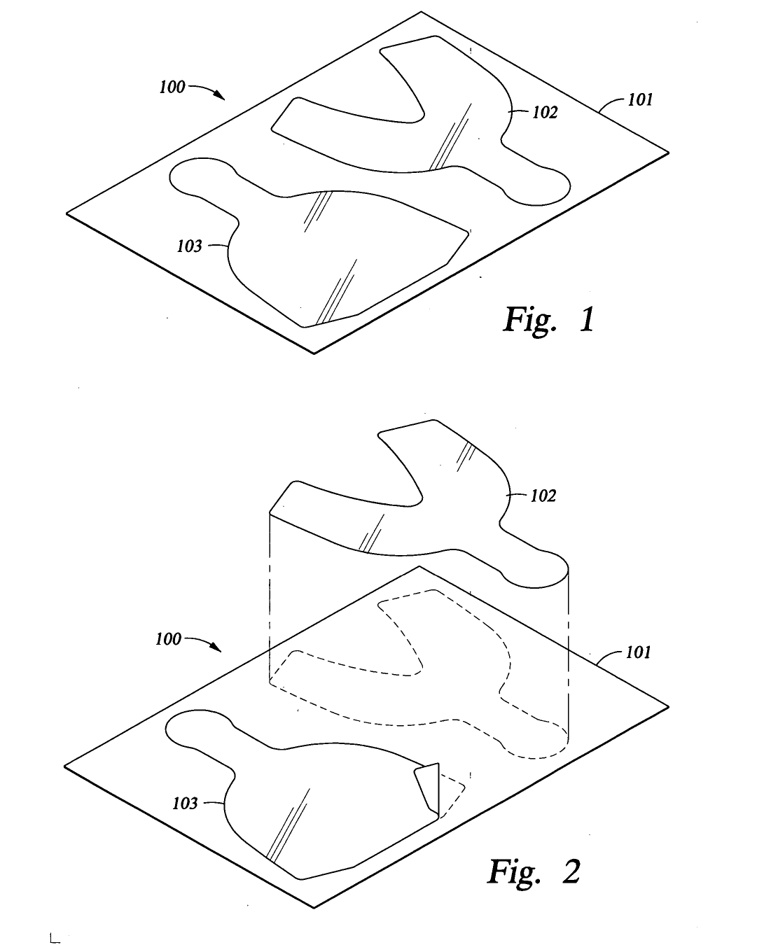

Referring additionally to FIG. 1, there is shown an illustration of impression spacer set 100, having backing sheet 101, lower impression spacer 102, and upper impression spacer 103. Impression spacers 102 and 103 are removably connected to backing sheet 101 by any suitable manner. While impression spacer set 100 is shown as having two spacer sheets, it should be understood that any suitable number of 1 or more sheets may be placed on backing sheet 101. As shown, impression set 100 would allow for a full upper and lower impression of a patient's mouth, and serve as a control against cross-contamination between patients, as it is intended for single patient use.

Spacer 102 is typically a thin film or sheet, which functions to provide a small gap/space between the teeth and impression material, to allow for the later application of a final impression material. The thickness of such a spacer will generally depend upon the impression materials utilized, and the specific application at hand. While a spacer thickness may be utilized that is outside (i.e., either above or below) the following ranges, in most cases, the spacer thickness would most likely would be in a range, which at the lower end of the range is preferably about 0.001 miles, more preferably about 0.01 mils, even more preferably at least about 0.1 mils, still more preferably at least about 1 mil, and yet more preferably at least about 1.5 mils, and which at the upper end of the range is preferably about 1000 mils, more preferable about 500 mils, even more preferably about 100 mils, still more preferably about 10 mils, and yet more preferably about 3 mil. Suitable ranges are obtained by selecting one of the above lower ends and one of the upper ends for the range. Non-limiting examples of suitable ranges for the thickness of the spacer include about 0.001 mils to about 1000 mils, about 0.01 mils to about 500 mils, about 0.1 mils to about 100 mils, about 0.1 mils to about 10 mils, about 0.1 mils to about 3 mils, about 1 mil to about 100 mils, about, 1 mil to about 10 mils, about 1 mil to about 3 mils.

Materials suitable for the spacer sheet include any material, which can be formed into suitably sized sheets, which will cause any undue health/safety effects, and which are suitable for serving as a spacer to obtain the preliminary impression on the preliminary impression material. Non-limiting examples of suitable materials include metal foils, polymeric materials, paper, natural and synthetic fibers cloth. Non-limiting examples of metal foils include gold, aluminum, copper, steel and the like. Non-limiting examples of polymeric materials, include thermoplastic and thermoset materials. It is also contemplated to use any combination of mixtures or multilayers of any of the foregoing. For example, a metal foil backed polymeric material, or a fiber or metal reinforced polymer layer.

The spacer material preferably comprises a polymer, more preferably comprises a thermoplastic, even more preferably comprises a polyolefin, and still more preferably a polyethylene or polypropylene, and yet more preferably comprises polyethylene. Applicants have obtained good results utilizing their preferred commercially available polyethylene food grade plastic wrap, which is on the order of about 0.1 to about 3 mils thick.

Referring additionally to FIG. 2, there is shown an illustration of impression spacer set 100 of FIG. 1, showing impression spacer 102 removed from backing sheet 101, and showing impression spacer 103 having portion 103A partially removed. It is preferred that the spacer sheets be easily removable to allow for speedy and convenient use.

Referring still to FIG. 4, a spacer 102 is positioned on impression material 112 forming preliminary impression tool 130. Optionally, spacer 102 is slightly pressed in a number of spots to slightly anchor it to impression material 112.

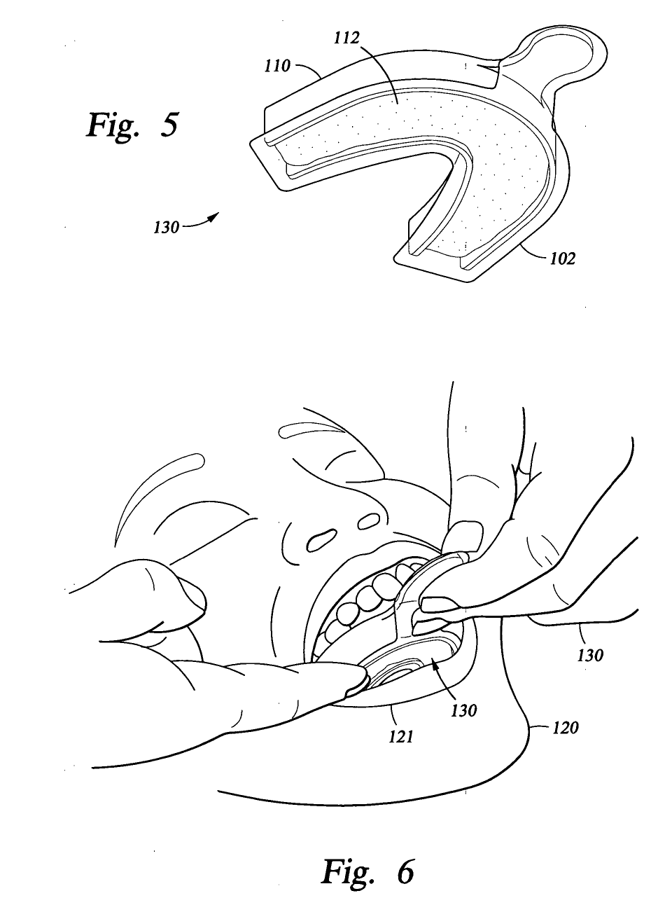

Preliminary impression tool 130 is shown fully assembled in FIG. 5, which is an illustration of tool 130 showing impression tray 110, impression material 112 residing in impression tray 110, with impression spacer 102 on top of impression material 112.

It should understood, that while spacer 102 is shown as being applied in sheet/film form, it is also contemplated that a spacer could be applied in a flowable form (i.e. liquid, gel, semi-solid or extrudable/workable solid) that would harden into a spacer sheet/film. It is contemplated that such a flowable spacer material could be sprayed, brushed, sprinkled, dripped, poured, dabbed, extruded, or otherwise applied to the preliminary impression material, including dipping the impression material in the flowable spacer material. This flowable spacer material would be subsequently allowed to form into a spacer layer.

Referring additionally to FIG. 6, there is shown an illustration of preliminary impression maker 130 being inserted into mouth 121 of patient 120 by dental professional 128. Using techniques known to those of skill in the art, preliminary impression maker 130 is manipulated into position and with force applied by the dental professional manually and/or by patient either manually or by biting down, a dental impression is obtained. One benefit of spacer 102, is that removal of preliminary impression maker 130 may be undertaken before full curing of impression material 112 has taken place because spacer 102 allows for easier removal.

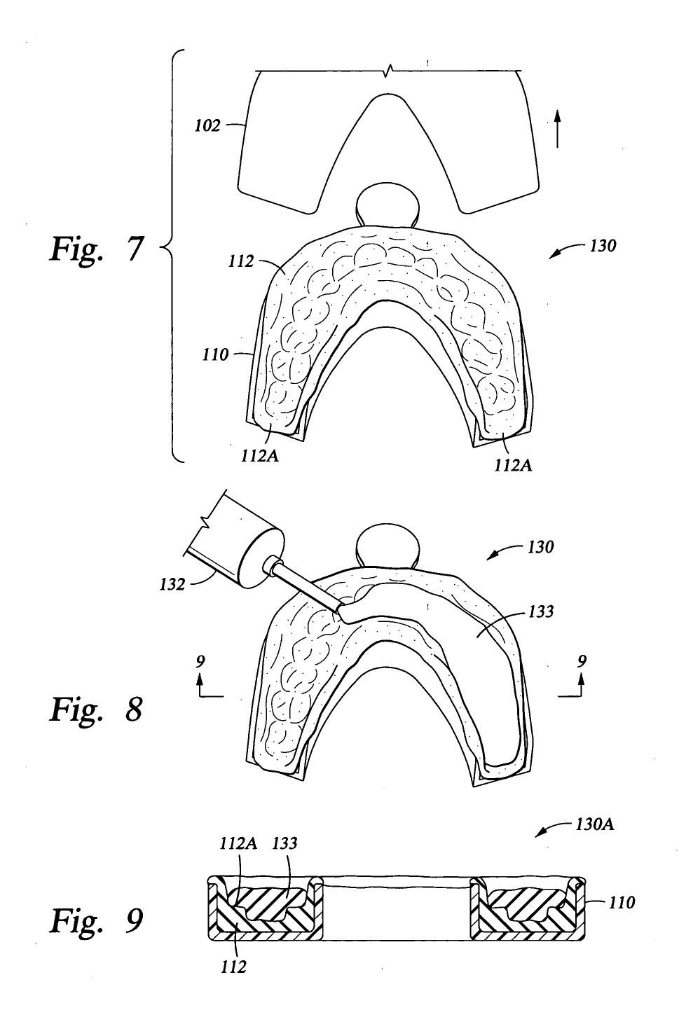

Once impression maker 130 is removed, spacer 102 is subsequently removed. Depending upon the spacer material and the impression material and the surface interaction between them, it may be possible to remove spacer 102 before full curing of impression material 112. Referring additionally to FIG. 7, there is shown preliminary impression maker 130 being unassembled, with impression spacer 102 being removed, revealing preliminary dental impressions 112A in impression material 112.

Referring additionally to FIG. 8, there is shown assembly of final impression maker 130A by application of final impression material 133 over preliminary dental impressions 112A with applicator 132. Final impression material 133 may be any suitable impression material. Final impression material 133 is selected from the same group as described for the preliminary impression material above, and may be the same or different than the preliminary impression material. While it is shown being applied in a flowable form it may also be applied as a solid sheet or in a moldable putty form.

Referring additionally to FIG. 9, there is shown a side view of final impression maker 130A of FIG. 8 at 9-9, showing impression tray 110, dental impression layer 112 with preliminary impressions 112A, and final impression material 133.

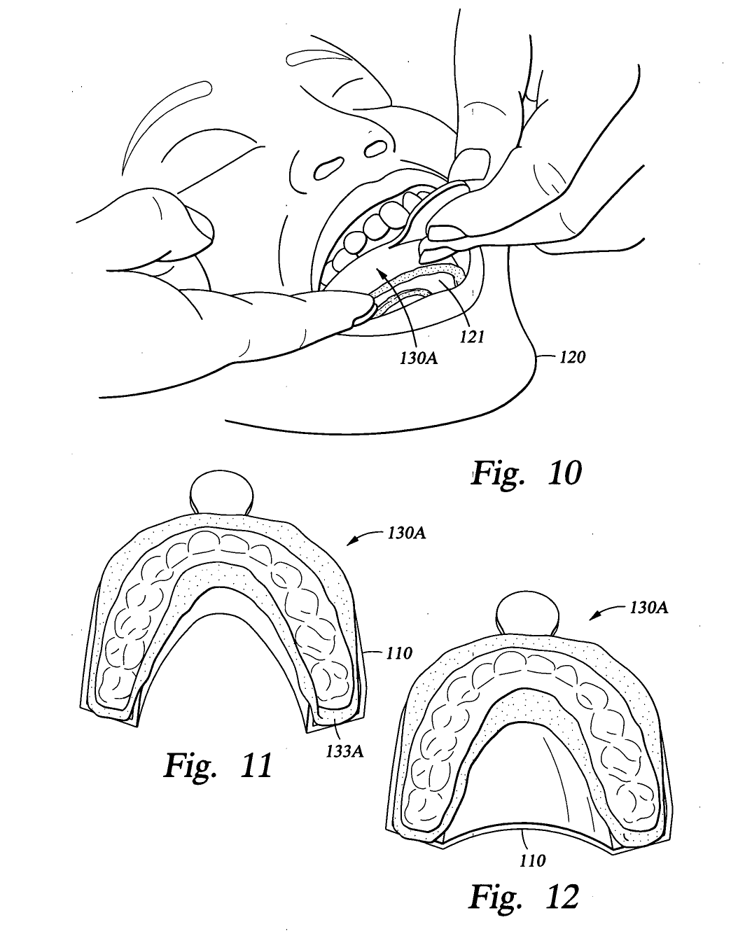

Referring additionally to FIG. 10, final impression maker 130A is then inserted into mouth 121 of patient 120.

Referring additionally to FIG. 11, final impression maker 130A is shown removed from patient's mouth and as having final impressions 133A. Contemplated as further methods of the present invention, these final impressions may be utilized with any known method/technique for making dental devices, such as inlays, onlays, crowns and bridges, removable prosthetic devices and orthodontic devices. The present invention also contemplates dental devices which are made using part of all of any method disclosed herein, which are made using any impression maker/tool disclosed herein, and/or which are made from part or all of any impression obtained by any method disclosed herein.

Referring now to FIG. 12, there is shown an illustration of an alternative impression tray 110 for taking upper mouth impressions.

Any and all patents, articles, papers, books, magazines and other referred to in this application are herein incorporated by reference for all that they disclose and teach.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

What is claimed is:

1. A method of making a final impression of an object surface, the method comprising the steps of:
(A) applying a spacer material to an impression material to form a preliminary impression tool;
(B) contacting the object with the preliminary impression tool in such a manner that the surface abuts the spacer material forming a preliminary impression of the object surface in the impression material;
(C) separating the preliminary impression tool from the object;
(D) removing the spacer material from the preliminary impression tool to reveal the preliminary impression of the object surface;
(E) applying a final impression material to the impression of the object to form a final impression tool;
(F) contacting the final impression tool against the object in such a manner as to orient the object in the preliminary impression of the object forming a final impression of the object surface in the final impression material.

2. A method of making a final impression of a tooth surface, the method comprising the steps of:
(A) applying a spacer material to a preliminary impression material to form a preliminary impression tool;
(B) contacting the tooth surface with the preliminary impression tool in such a manner that the surface abuts the spacer material forming a preliminary impression of the tooth surface in the preliminary impression material;
(C) separating the preliminary impression tool from the tooth surface;
(D) removing the spacer material from the preliminary impression tool to reveal the preliminary impression of the tooth surface;
(E) applying a final impression material to the impression of the tooth surface to form a final impression tool
(F) contacting the final impression tool against the tooth surface in such a manner as to orient the tooth surface in the preliminary impression of the tooth surface forming a final impression of the tooth surface in the final impression material.

3. The method of claim 2, further comprising:
(G) forming a model of the tooth surface from the final impression.

4. The method of claim 3, further comprising:
(H) forming a dental device from the model, wherein the dental device is selected from the group consisting of inlays, onlays, crowns and bridges, prosthetic devices and orthodontic devices.

5. The method of claim 2, wherein in step (A), the impression material is supported in a dental tray.

6. The method of claim 5, wherein the preliminary impression material and the final impression material, may be the same or different, and are selected from the group consisting of agar, alginates, polysulfides, polyethers, polysilicone, polysiloxanes, polysulfides, and zinc oxide-eugenols.

7. The method of claim 6, wherein the spacer material comprises at least one selected from the group consisting of metal foils, polymeric materials, paper, natural and synthetic fibers cloth.

8. The method of claim 6, wherein the spacer material comprises a polymer.

9. The method of claim 6, wherein the spacer material comprises a polyolefin.

10. The method of claim 6, wherein the spacer material comprises polyethylene, and the preliminary impression material and the final impression material may be the same or different and each comprise vinyl polysiloxane.

11. An impression spacing set comprising:
(A) a backing sheet;
(B) a first spacer shaped to fit into a lower dental tray; and,
(C) a second spacer shaped to fit into an upper dental tray.

12. An impression tool comprising:
(A) a dental impression material; and,
(B) a spacer material supported by the impression material.

13. The tool of claim 12, wherein the dental impression material is supported in a dental impression tray.

14. The tool of claim 13, wherein the spacer material comprises at least one selected from the group consisting of metal foils, polymeric materials, paper, natural and synthetic fibers cloth.

15. The tool of claim 13, wherein the spacer material comprises a polymer.

16. The tool of claim 13, wherein the spacer material comprises a polyolefin.

17. The tool of claim 13, wherein the dental impression material is selected from the group consisting of agar, alginates, polysulfides, polyethers, polysilicone, polysiloxanes, polysulfides, and zinc oxide-eugenols.

18. An impression tool comprising for taking an impression of a surface, comprising:
(A) a first impression material defining a preliminary impression of the surface; and
(B) a second impression material residing in the impression of the surface.

19. The tool of claim 18, wherein the first impression material is supported in a dental tray.

20. The tool of claim 19, wherein the first impression material and the second impression material, may be the same or different, and are selected from the group consisting of agar, alginates, polysulfides, polyethers, polysilicone, polysiloxanes, polysulfides, and zinc oxide-eugenols.
